(19) United States
(12) Patent Application Publication
(10) Pub. No.: US 2003/0120883 A1
(43) Pub. Date: Jun. 26, 2003

(54) Electronic processing device and method of pipelining in such a device

(76) Inventors: Glenn Ashley Farrall, Long Ashton (GB); Neil Stuart Hastie, Lydney (GB); Erik Karl Nordan, Santa Clara, CA (US)

Correspondence Address: LERNER AND GREENBERG, P.A., Post Office Box 2480, Hollywood, FL, 33022-2480, US

(21) Appl. No.: 10/304,369

(22) Filed: Nov. 26, 2002

(30) Foreign Application Priority Data
Nov. 26, 2001 (GB) 01 282 86.2

(51) Int. Cl. G06F 12/00

(52) U.S. Cl. 711/169

(57) ABSTRACT

An electronic processing device has an integer pipeline and a load/store pipeline disposed in parallel to receive a series of instructions via a Fetch stage and a Predecode stage. If an instruction is stalled in a Decode stage of the integer pipeline, one or more Delay stages can be switched into and out of the integer pipeline between the Decode stage and the Predecode stage so as to increase or decrease its effective length. This allows the Predecode stage to continue to issue instructions and therefore the load/store pipeline does not need to stall. The maximum number of delay stages that need to be available for switching into the integer pipeline is the same as a load-use penalty for that pipeline.

### BACKGROUND OF THE INVENTION

### FIELD OF THE INVENTION

The invention relates, in general, to an electronic processing device and to a method of pipelining in such a device, and more particularly, though not exclusively, to a superscalar electronic processing device having multiple pipelines and to a method of pipelining instructions in such a device.

As is well known, many instructions provided to an electronic processing device, such as a microprocessor, require a number of steps to be carried out by the processor. For example, an instruction to carry out an arithmetic operation on a pair of numbers which are stored in a memory requires that the two numbers be obtained from the correct addresses in the memory, that the arithmetic operation be obtained from a memory location, that the two numbers be operated on according to the arithmetic operation, and that the result be written back into the memory so that it can be used in a subsequent operation. Many of the steps must be carried out in sequence in consecutive clock cycles of the processor. Thus, a number of clock cycles will be taken up for each instruction.

It is also known that the operation of such an electronic processing device can be sped up by use of so-called pipelines. A pipeline in such a device is a series of stages carrying out the different steps of the instruction, with each stage carrying out one step, and the instruction then moving on to the next stage where the next step is carried out. In this way, a series of instructions can be moved into the pipeline one by one on each clock cycle, thereby increasing the throughput since each instruction only needs to wait until the first stage of the pipeline is available, rather than waiting for the whole of the previous instruction to be completed.

A scalar pipeline is a pipeline into which a maximum of one instruction per cycle can be issued. If all data and control stalls in the pipeline can be eliminated, the ideal situation of one clock cycle per instruction (1 CPI) is achieved. However, it is desirable to reduce the number of clock cycles per instruction still further (CPI<1). To do this, more than one instruction per cycle needs to issue from the pipeline. Thus, a superscalar device is one into which multiple instructions may be issued per clock cycle. Ideally, an N-way superscalar processing device would allow the issue of N instructions per clock cycle. However data and control stalls caused by pipeline hazards apply equally to superscalar systems. This limits the effective number of instructions that can be issued per clock cycle.

There may be different pipelines optimized for different types of instructions. For example, load/store instructions may be directed to one type of pipeline, and arithmetic instructions may be directed to a different type of pipeline, which may also be further divided into, for example, integer or floating point type pipelines. There can therefore be a number of pipelines disposed in parallel in a device, with different numbers of different types of pipeline being possible.

Thus, when instructions are fetched from memory, they are first predecoded to determine which type of instruction they are so that they can be directed to the appropriate type of pipeline, in which they are passed to a decode stage. In general, the Fetch and Predecode stages are configured to allow for a number of instructions to be handled at once, so that, by arranging for sets, of the same number and types of instruction as there are pipelines, to be disposed together by the programmer of compiler, such a set can be passed through to the Decode stage of each of the pipelines on the same clock cycle. The set of instructions is then executed and written back to the memory in parallel on the same clock cycles, while the next sets of instructions are passed through the pipeline stages.

As is known, however, if an operand required for one of the instructions is not yet available, for example because it requires the result of an earlier instruction that is still in a pipeline and has not yet been written back into the memory, then the instruction requiring that operand cannot proceed and the instruction stalls at the Decode stage. Usually, if an instruction is stalled at the Decode stage, then the other instructions of that set are also stalled in their pipelines, so that all the instructions forming the set maintain their relationship through the pipelines so that the results come out in the same order that the instructions were entered into the pipeline. However, this results in that not only the instruction requiring the missing operand is stalled, as are, of course, all subsequent instructions in that pipeline, but so are the other instructions of the set that follow the stalled instruction in the program flow, and all subsequent instructions in those pipelines also. This stall behavior is well known in pipelines. When a stall is induced by a memory load followed immediately by the use of a loaded value, this is known as the load-use penalty and depends on the number of clock cycles for which an instruction will stall. It will be appreciated that this depends on the number of stages in the pipeline and, for longer pipelines, can become quite large.

### SUMMARY OF THE INVENTION

It is accordingly an object of the invention to provide an electronic processing device and a method of pipelining in such a device that overcome the above-mentioned disadvantages of the prior art devices and methods of this general type, which reduces the load-use penalty.

With the foregoing and other objects in view there is provided, in accordance with the invention, an electronic processing device. The electronic processing device contains at least two pipelines disposed in parallel to receive a series of instructions. Each of the pipelines has a plurality of stages through which the instructions pass, and at least one of the pipelines has at least one delay stage being switchable into and out of the pipeline to increase or decrease an effective length the pipeline.

Accordingly, in a first aspect, the electronic processing device has the at least two pipelines disposed in parallel and receives a series of instructions. Each pipeline has a plurality of standard stages through which the instructions pass, and at least one of the pipelines is provided with at least one delay stage that is switchable into and out of the pipeline to increase or decrease its effective length.

In a preferred embodiment, the electronic processing device further contains a control device for controlling the delay stage to switch it into and out of the pipeline depending on whether a previous instruction in the pipeline is stalled or not.

According to a second aspect of the invention, there is provided a method of pipelining in an electronic processing device having at least two pipelines disposed in parallel to receive a series of instructions, and each pipeline has a plurality of stages through which the instructions pass. The method contains the steps of at a first clock cycle, providing a first respective instruction to a first stage of each of the respective pipelines; and at subsequent clock cycles, providing a subsequent respective instruction to the first stage of each respective pipeline, and, unless a previous instruction is stalled in a pipeline, moving each respective instruction to the next stage of the respective pipeline. Wherein, if a previous instruction is stalled in a pipeline, a delay stage is switched into that pipeline to receive the next instruction.

Preferably, if a previous instruction is stalled in a pipeline, the instructions in the other pipeline(s) are not stalled or delayed.

In a preferred embodiment, a plurality of delay stages are available for switching into a series in a pipeline.

The or each delay stage is preferably switched into the pipeline between a predecode stage and a decode stage of the pipeline.

In one embodiment, the delay stage is switched into the pipeline between a predecode stage and a decode stage, if a previous instruction is stalled in the decode stage, and wherein the delay stage is switched out of the pipeline if the predecode stage has no instruction to pass to any decode stage.

Preferably, one delay stage of a plurality of delay stages is switched into a series of delay stages in the pipeline adjacent the predecode stage per clock cycle if a previous instruction is stalled in the decode stage, and wherein one delay stage adjacent the predecode stage is switched out of the pipeline per clock cycle if the predecode stage has no instruction to pass to any decode stage.

The pipeline provided with the delay stage being switchable into and out of the pipeline is preferably an integer pipeline and the other pipeline is preferably a load/store pipeline.

Preferably, the maximum number of delay stages in a series in a pipeline is equal to the load-use penalty for that pipeline.

In accordance with an added feature of the invention, an instruction flow controller is provided for determining which of the instructions in the pipelines can continue, and which of the instructions must stall and which results can be forwarded to the decode stage if the decode stage requires a result that is not immediately available to the decode stage. The instruction flow controller determines a stalling of the instructions and a forwarding of the results according to a relative age of the instructions in the pipelines. The instruction flow controller determines how many of the delay stages are switched into the pipeline and utilizes a Q-value in determining a stalling of the instructions and the forwarding of the results. The instruction flow controller determines the stalling of the instructions and the forwarding of the results according to a set of rules for providing relative ages of the instructions in the pipelines for different Q-values. The set of rules include the following rules for providing an age order of the instructions in different ones of the stages in the pipelines (A and B):

For Q=0: B-Ex2, A-Ex1, B-Ex1, A-D, B-D, PD, F

For Q=1: B-Ex2, A-D, B-Ex1, A-Q1, B-D, PD, F

For Q=2: B-Ex2, A-Q1, B-Ex1, A-Q2, B-D, PD, F,

wherein the pipelines each have two execution stages (Ex1 and Ex2), the decode stage (D), the predecode stage (PD), a fetch stage (F) and the delay stages according to the Q-value.

Other features which are considered as characteristic for the invention are set forth in the appended claims.

Although the invention is illustrated and described herein as embodied in an electronic processing device and a method of pipelining in such a device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of a pair of pipelines in a superscalar electronic processing device according to the invention;

FIG. 2 is an instruction/cycle diagram showing which stages of the pipelines particular instructions are in during clock cycles in a superscalar electronic processing device according to one embodiment of the present invention;

FIGS. 3A-3C are block diagrams illustrating the instructions passing through the pair of pipelines during clock cycles 3, 4 and 5 and showing how one of the pipelines is effectively increased in length during cycles 4 and 5;

FIGS. 4A-4C are block diagrams illustrating the instructions passing through the pair of pipelines during clock cycles 10, 11 and 12 and showing how one of the pipelines is effectively decreased in length during cycles 10 and 11; and

FIG. 5 is a block diagram of a physical implementation of two delay stages between a predecode stage and a decode stage of a pipeline according to an embodiment of the invention.

### DESCRIPTION OF THE PREFERRED EMBODIMENTS

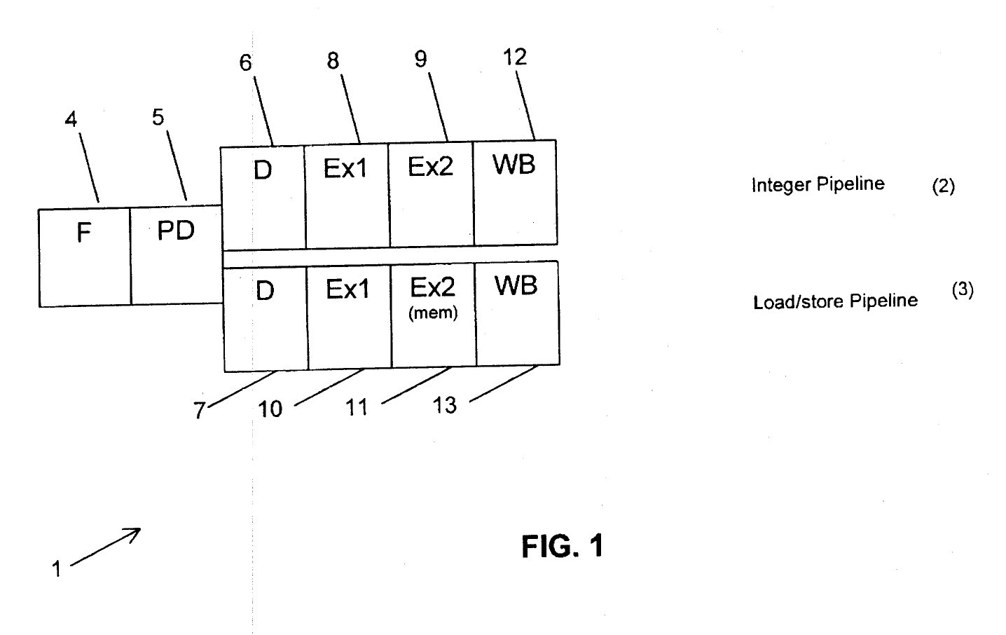

Referring now to the figures of the drawing in detail and first, particularly, to FIG. 1 thereof, there is shown a six-stage pipeline system 1 in a superscalar electronic processing device having one integer pipeline 2 and one load/store pipeline 3. Each of the pipelines 2 and 3 are formed of six stages, in this embodiment, with a first stage being a Fetch (F) stage, a second stage being a Predecode (PD) stage, a third stage being a Decode (D) stage, the next two stages being Execute (Ex1 and Ex2) stages and the final stage being a Writeback (WB) stage. Since an instruction must be at least predecoded before it can be determined which of the two pipelines it is meant for, the first two stages of the pipelines, the Fetch (F) stage 4 and the Predecode (PD) stage 5, are shared by the integer pipeline 2 and the load/store pipeline 3. After the predecoding stage 5, when it has been determined which type of pipeline the instruction should be passed to, the instruction is passed to either a integer Decode (D) stage 6 or an load/save Decode (D) stage 7. It will be appreciated that the Fetch and Predecode stages 4 and 5 are twice the width of the stages in each of the pipelines 2 and 3 to enable two instructions to be handled simultaneously by the Fetch and Predecode stages so that an instruction can be passed to both the store/load and integer pipelines at the same time.

A programmer or compiler usually attempts to provide alternating integer and load/store instructions so that they can be paired together in program order in the Predecode stage 5. Ideally an integer instruction will be paired with an immediately following load/store instruction where possible, such that the integer instruction is the older of the pair. Thus, ideally, one such pair of instructions is issued to the appropriate Decode stages of the load/store and integer pipelines on each clock cycle. If this is not possible, the instructions are issued to the Decode stage(s) separately.

The decode stages 6 and 7 in both the integer pipeline 2 and the load/store pipeline 3 gather together the source operands for the instruction execution and pass the operands to the next stages in the pipeline, which are the first and second Execution (Ex1 and Ex2) stages 8 and 9 in the integer pipeline 2 and the first and second Execution (Ex1 and Ex2) stages 10 and 11 in the load/store pipeline 3. The integer pipeline Execution stages 8 and 9 perform the integer operation required by the instruction, and the load/store pipeline Executions stages 10 and 11 perform the load or store operations required by the instruction. The actual accessing of the memory is performed in Execution stage 11. The result of the instruction execution are then passed to the Writeback (WB) stages 12 and 13, which return the result of the instruction execution back to the memory or register file.

The operands required by the Decode stages 6 and 7 may be held in a register file or in-flight in one or other of the pipelines. Result forwarding in the pipelines allows results to be forwarded back to the Decode stage of a pipeline as soon as they become available, without needing to wait for them to issue from the Writeback stage. In the case of the integer pipeline 2, this may be from either of the Execution stages 8 and 9 or from the Writeback stage 12, although, in the case of a load/store instruction, this can only be forwarded from the Writeback stage 13.

If an operand is not available when required by the Decode stage, then the Decode stage will stall until the operand becomes available. In this system, when any pipeline stalls, all earlier pipe stages, that is the stages before the stalling stage in the pipeline, must also stall, in order to maintain the ordering of instructions within the pipeline. Thus, if the integer pipeline Decode stage 6 stalls, then the load/store Decode stage 7 and the Predecode and Fetch stages 5 and 4 must also stall.

In order to determine which pipeline stages must stall it is important to know which instructions are younger than the stalling instruction and which are older. The younger ones need to stall to maintain instruction ordering, the older ones are not affected by the stall and must continue. The relative age of instructions can be established by inspecting the pipelines according to a few simple rules:

a). An instruction will be older than any other instruction in a pipeline stage to its left in the pipeline.

b). Conversely an instruction will be younger than any other instruction in a pipeline stage to its right.

c). An instruction in a particular stage of the integer pipeline will be older than an instruction in the equivalent stage of the load/store pipeline.

d). Conversely, an instruction in a particular stage of the load/store pipeline will be younger than an instruction in the equivalent stage of the integer pipeline.

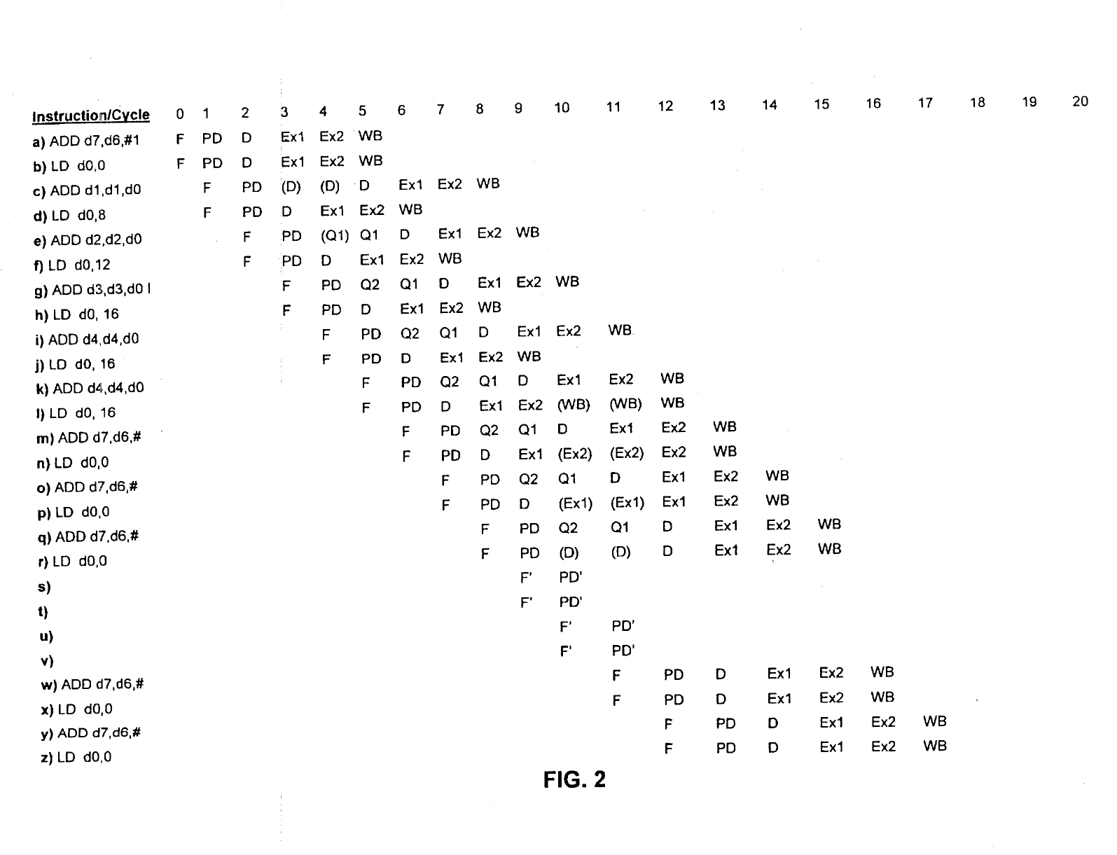

FIG. 2 shows how instructions flow down the pipelines, indicating which stage an instruction is at for particular clock cycles. Thus, for example, instructions (a) and (b) both enter the Fetch stage at clock cycle 0, move to the Predecode stage at clock cycle 1 and then continue on successive clock cycles to move through the Decode and Execution stages and issue from the Writeback stages on clock cycle 5. In this example, the instructions (a)-(c) mean the following:

a) ADD d7, d6, #1; Add 1 to d6 and place the result in d7

b) LD d0,0; Load register d0 from memory location 0

c) ADD d1, d1, d0; Add d0 to d1 and place the result in d1

It will be seen, therefore, that instruction (c) is dependent on instruction (b) because the instruction (c) needs to wait for do to be loaded with the instruction (b). Therefore, turning back to FIG. 2, it will be seen that the instruction (c) passes through the Fetch and Predecode stages normally on clock cycles 1 and 2, but then stalls in the Decode stage on clock cycles 3 and 4 (as shown by brackets around the D), before the result of instruction (b) is made available from the Writeback stage in clock cycle 5, which can therefore be obtained by the Decode stage for instruction (c) and then passed forward for execution in clock cycle 6. Hitherto, this would have meant, as mentioned above, that the paired load/store instruction (d) would also need to be stalled in the Decode stage for clock cycles 3 and 4. However, according to the present embodiment of the invention, the load/store instructions no longer need to be stalled and can progress normally through the load/store pipeline, as seen in FIG. 2. Nevertheless, with instruction (c) stalled in the Decode stage in clock cycles 3 and 4, this results in that instruction (e), which issues from the Predecode stage in clock cycle 3, cannot now be passed to the Decode stage. Therefore, according to this embodiment of the invention, instead of stalling instruction (e), as would have occurred in prior art devices, instruction (e) is now passed to a first Delay stage Q1 in clock cycle 3. Of course, since the decode stage is stalled in clock cycle 3, the instruction (e) is stalled in Delay stage Q1, in clock cycle 4, until clock cycle 5, when instruction (c) issues from the Decode stage, allowing instruction (e) to issue from Delay stage Q1 into the Decode stage. However, turning now to instruction (g), it will be apparent that, in clock cycle 4, it cannot issue from the Predecode stage to Delay stage Q1 because instruction (e) is still in Delay stage Q1. Therefore, instruction (g) is passed to a second Delay stage Q2. From the second Delay stage Q2, instruction (e) can then pass normally in subsequent clock cycles through the first Delay stage Q1 to the Decode stage and then through the Execution stages Ex1 and Ex2 to the Writeback stage. From this point, as long as there are instructions flowing through both pipelines, the two Delay stages Q1 and Q2 are included in the integer pipeline between the Predecode and the Decode stages.

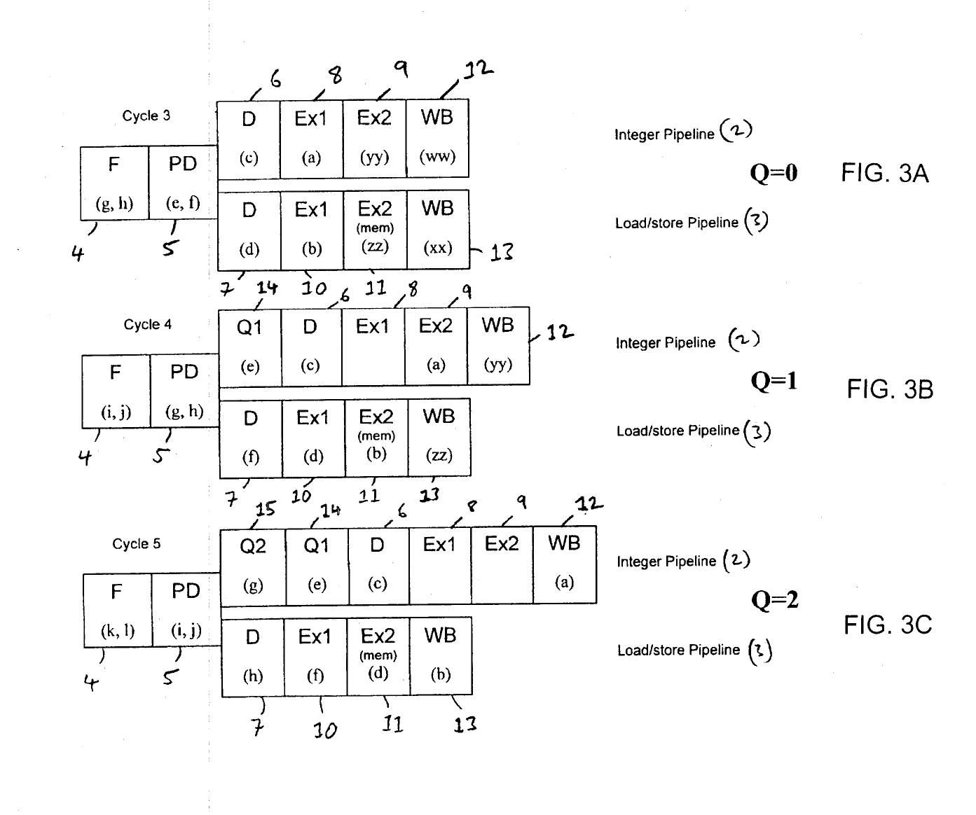

This is more clearly shown in FIGS. 3A-3C, the same pipelines as shown in FIG. 1 are shown with the same reference numbers, but indicating which instructions are present in each of the stages in each of clock cycles 3, 4 and 5 in FIGS. 3A, 3B and 3C, respectively. Thus, turning first to FIG. 3A, and referring also to FIG. 2, at clock cycle 3, instructions (g) and (h) are in the Fetch stage 4, instructions (e) and (f) are in the Predecode stage 5, instruction (c) is in the Decode stage 6 of the integer pipeline 2, instruction (a) is in the first Execution stage 8 of the integer pipeline 2 and instruction (d) is in the Decode stage 7 and instruction (b) is in the first Execution stage 10 of the load/store pipeline 3. FIGS. 3A-3C show previous instructions (zz), (yy), (xx) and (ww) in later stages of the pipelines, although they are not shown in FIG. 2.

In FIG. 3B, in the next clock cycle 4, it will be seen that instructions (g) and (h) have moved to the Predecode stage 5 from the Fetch stage 4, where they have been replaced by the next pair of instructions (i) and (j). Similarly, instruction (f) has moved to the Decode stage 7 of the load/store pipeline 3, with all the previous instructions in that pipeline moving forward by one stage. However, in the integer pipeline 2, instruction (c) is stalled in the Decode stage 6, as was described above. Thus, although the previous instructions (a) and (yy) in the integer pipeline 2 can move forward to the second Execution stage 9 and the Writeback stage 12, respectively, instruction (e) cannot issue from the Predecode stage 5 to the Decode stage 6, since the Decode stage 6 has not issued instruction (c). Instead, a first Delay (Q1) stage 14 is switched into the integer pipeline 2 between the Predecode stage 5 and the Decode stage 6. In this way, the progress of the later instructions through the Fetch and Predecode stages 4 and 5 is not impeded, and the progress of instructions through the load/store pipeline 3 can continue normally.

As shown in FIG. 3C, in the next clock cycle 5, all the instructions passing through the load/store pipeline 3 continue to the next stage, and all the instructions passing through the Fetch and Predecode stages 4 and 5 also continue on to the next stage, except that instruction (g) issuing from the Predecode stage 5 cannot pass to the first Delay stage 14, since that still has instruction (e) stalled in it due to the fact that instruction (c) is still in the Decode stage 6. Therefore, just as the first Delay stage 14 was added in the previous clock cycle 4 (FIG. 3B), so a second Delay (Q2) stage 15 is added in the clock cycle 5 to the pipeline 2 between the Predecode stage 5 and the first Delay stage 14 and the instruction (g) is passed to the second Delay stage 15.

It should be noted that instruction (e) now completes the Writeback stage in clock cycle 9, whereas its paired instruction (f) completes in clock cycle 7. The rules for establishing the relative age of instructions mentioned above still apply. However, the number of Delay stages in use must also be used in order to correctly determine which stages to stall or forward from. For a stall in the second Execution stage of the load/store pipeline, all younger instructions must be stalled. Using the rules mentioned above and by inspection of the different pipeline diagrams, the stages are, in age order:

For Q=0: LS-Ex2, IP-Ex1, LS-EX1, IP-D, LS-D, PD, F

For Q=1: LS-Ex2, IP-D, LS-Ex1, IP-Q1, LS-D, PD, F

For Q=2: LS-Ex2, IP-Q1, LS-Ex1, IP-Q2, LS-D, PD, F

Where the LS prefix refers to the load/store pipeline and the IP prefix refers to the integer pipeline. Thus, the ease of determining stall and forwarding information, based as it is on the single global value of the number of Delay stages (Q-value), leads to a simple implementation and is an important advantage of this embodiment of the invention.

As will be apparent from following instruction (c) in FIG. 2, since the load/store pipeline 3 has only two Execution stages, instruction (c) is stalled for two clock cycles, so that the load-use penalty for the “standard” pipelines (without any delay stages) is two. Therefore, the maximum number of Delay stages that need to be available for switching into the pipeline is two. With two Delay stages, and the pipelines in a “steady state”, as can be seen for instructions (g), (i) and (k), the instructions are emerging from the Writeback stage at successive clock cycles, showing that there is no further delay being caused in the pipeline. Thus, the load-use penalty has been reduced to effectively one when one Delay stage has been switched into the pipeline and has been minimized to effectively zero when both Delay stages are switched into the pipeline.

Nevertheless, it may be undesirable to simply add the two Delay stages and then keep them in the pipeline, since, if there are branches in the pipelines which have been mispredicted, all the instructions following the misprediction must be discarded. In such a case, the greater the number of stages that are discarded, the greater the number of clock cycles before the pipeline is once again full, so that the pipelining is not efficient. It is therefore desirable to minimize the pipeline length whenever possible, although it is also possible to provide code specifically written to avoid load-use penalties to run only on a Q=0 pipeline to maintain optimum branch latency.

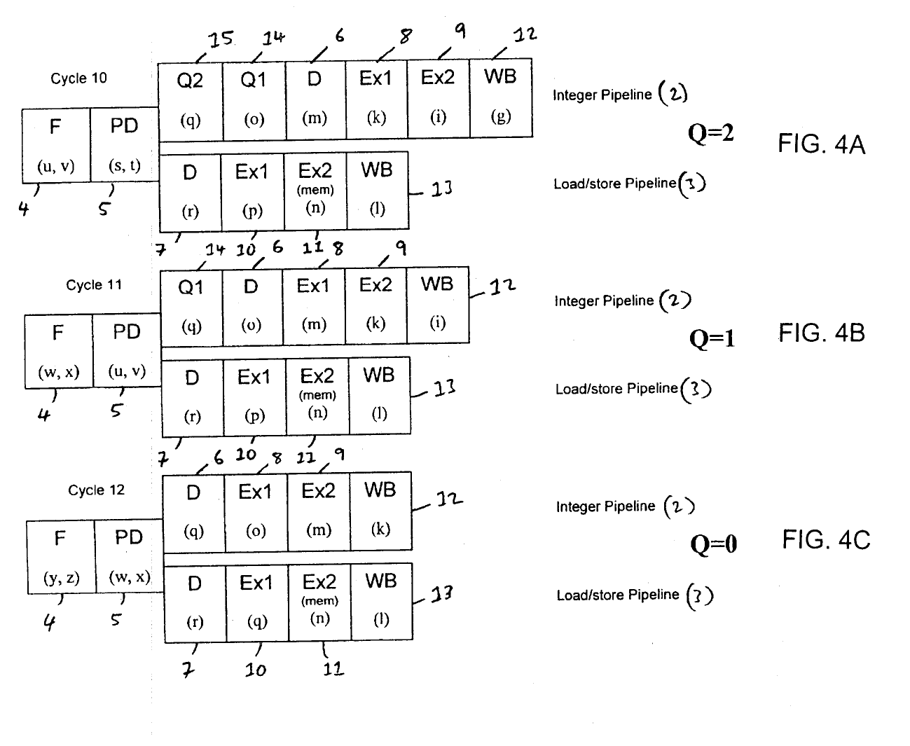

In order to minimize the pipeline length, the Delay stages can be switched out of the pipeline, at a rate of one per clock cycle, when there are no instructions to issue from the Predecode stage into either of the integer or load/store pipelines. This can happen in cases of instruction cache misses, branch misprediction, etc. Delay stages can also be removed when there are no valid instructions in the integer pipeline (i.e. when there is a long sequence of load/store instructions with no integer instructions). In order to maintain instruction ordering whenever Delay stages are removed from the pipeline, it is necessary to stall the load/store pipeline. This is shown in FIG. 2 and FIGS. 4A-4C at clock cycles 10, 11 and 12.

As can be seen at clock cycle 9 in FIG. 2, the pair of instructions entering the Fetch stage are instructions (s) and (t), which are null, so that the Fetch stage is empty (F′). As then seen at clock cycle 10 in FIG. 2 and in FIG. 4A, instructions (s) and (t) are passed to the Predecode stage 5 from the Fetch stage 4, where they are replaced by instructions (u) and (v), which are also null. The integer pipeline 2 has instructions (q), (o), (m), (k), (i) and (g) moving normally through successive stages 15, 14, 6, 8, 9 and 12 in the pipeline 2, which includes two Delay stages 15 and 14, whereas the load/store pipeline 3 is stalled, with instructions (r), (p), (n) and (1) stalled in the Decode, first and second Execute and Writeback stages 7, 10, 11 and 13 of the load/store pipeline 3.

In clock cycle 11 (FIG. 4B), the load/store pipeline 3 is still stalled, but the instructions in the integer pipeline 2 move normally through the successive stages. However, since instructions (s) and (t), which should now issue from the Predecode stage 5 of the pipeline, are null, nothing passes through to the Decode stage 7 of the load/store pipeline 3 (which stage is in any event stalled), and the second Delay stage 15 is switched out of the integer pipeline 2. It will be seen that null instruction (u) and (v) pass to the Predecode stage 5 and are replaced in the Fetch stage 4 by new instructions (w) and (x), which are not null.

In the next clock cycle 12 (FIG. 4C), the load/store pipeline 3 having been stalled for two clock cycles, is ready to issue instructions to the next successive stage. The instructions in the integer pipeline 2 move normally through the successive stages. However, since instructions (u) and (v), which should now issue from the Predecode stage 5 of the pipeline, are null, nothing passes through to the Decode stage 7 of the load/store pipeline 3 (which stage is in any event still full), and the first Delay stage 14 is switched out of the integer pipeline 2. The integer pipeline is therefore back to its “original” length with Q=0, and the following instructions pass through the pipelines in the normal manner, as shown in the remainder of FIG. 2.

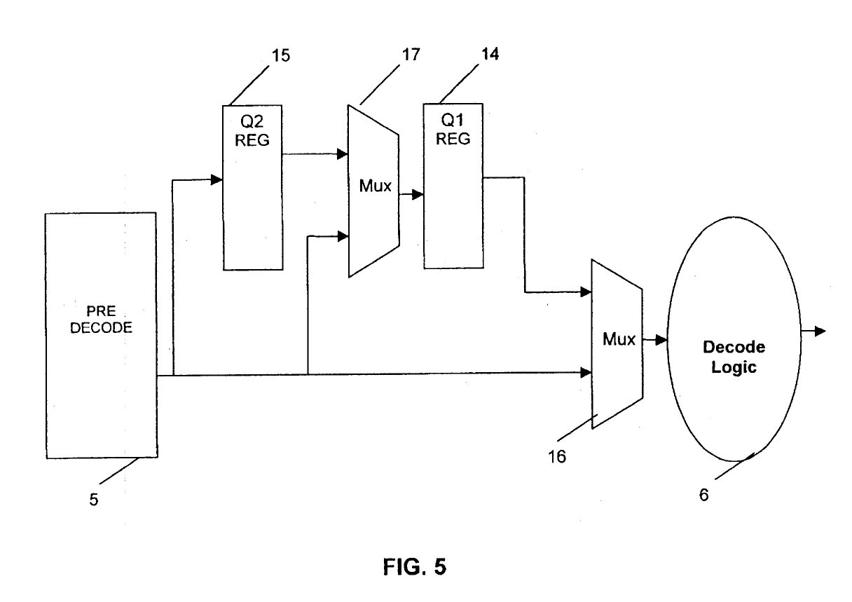

FIG. 5 shows, schematically, a physical implementation of part of the integer pipeline of FIGS. 3A-C and 4A-C between the predecode stage 5 and the decode stage 6. A first multiplexer 16 is provided between the Predecode stage 5 and the Decode stage 6. The first multiplexer 16 has an output coupled to an input of the Decode stage 6 and a pair of inputs, a first of which is coupled directly to an output of the Predecode stage 5, and a second of which is coupled to an output of the first Delay stage 14. A second multiplexer 17 is provided between the first Delay stage 14 and the second Delay stage 15. The second multiplexer 17 has an output coupled to an input of the first Delay stage 14 and a pair of inputs, a first of which is coupled directly to the output of the Predecode stage 5, and a second of which is coupled to an output of the second Delay stage 15.

Thus, if a previous instruction is stalled in the Decode stage 6, an instruction cannot issue directly to the Decode stage 6 from the Predecode stage 5 via the multiplexer 16. Instead, the instruction from the Predecode stage 5 issues via the second multiplexer 17 to the first Delay (Q1) stage 14, unless there is an instruction in the first Delay stage 14 that cannot issue, in which case the instruction from the Predecode stage 5 issues directly to the second (Q2) Delay stage 15, as was described above. The first and second multiplexers 16 and 17 thus provide the “switching” function, allowing the instructions to flow into a stage either from the Predecode stage 5 or from the previous Delay stage. Of course, the second Delay stage 15 does not need a multiplexer between it and the Predecode stage 5 since an instruction flowing into the second Delay stage 15 can only come from the Predecode stage 5.

It will be apparent from the above description, that the embodiment of the invention described above can be considered as a number of static pipelines of differing lengths, the particular pipeline being used depending on previous instructions. Each of the different pipelines has a different effective length so that their effective load-use penalty differs and the most appropriate one can be chosen so as to minimize the actual load-use penalty for a particular instruction, depending on previous instructions being executed.

While only one particular embodiment of the invention has been described above, it will be appreciated that a person skilled in the art can make modifications and improvements without departing from the scope of the present invention. For example, the control mechanism for switching the delay stages into and out of the pipeline can be different from that described above. Furthermore, as mentioned above, the number of delay stages available for switching can be varied according to the length of the pipeline and the required efficiency and predominant types of pipelines in the device. There could be several different types of pipeline, rather than two types as described above, and more than one of them, possibly all of them, could have delay stages available to them to change their effective lengths, if necessary.

We claim:

1. An electronic processing device, comprising:
at least two pipelines disposed in parallel to receive a series of instructions, each of said pipelines having a plurality of stages through which the instructions pass, and at least one of said pipelines has at least one delay stage being switchable into and out of said pipeline to increase or decrease an effective length said pipeline.

2. The electronic processing device according to claim 2, wherein said pipeline has a predecode stage and a decode stage, and said delay stage is switched into said pipeline between said predecode stage and said decode stage.

3. The electronic processing device according to claim 2, further comprising a control device for controlling said delay stage by switching said delay stage into and out of said pipeline depending on whether a previous instruction in said pipeline is stalled or not.

4. The electronic processing device according to claim 3, wherein said control device controls said delay stage to switch it into said pipeline between said predecode stage and said decode stage, if a previous instruction is stalled in said decode stage, and said control device controls said delay stage to switch it out of said pipeline if said predecode stage has no instruction to pass to said decode stage.

5. The electronic processing device according to claim 3, wherein said delay stage is one of a plurality of delay stages switchable into and out of a series of said delay stages in said pipeline to increase or decrease said effective length of said pipeline.

6. The electronic processing device according to claim 5, wherein said series of said delay stages is switched into said pipeline between said predecode stage and said decode stage.

7. The electronic processing device according to claim 6, wherein said control device controls said delay stages by switching said delay stage, adjacent to said predecode stage, into said series of said delay stages per clock cycle if the previous instruction is stalled in a next stage subsequent to said predecode stage, and said control device controls said delay stages to switch said delay stage adjacent said predecode stage out of said pipeline per clock cycle if said predecode stage has no instruction to pass to said decode stage.

8. The electronic processing device according to claim 5, wherein a maximum number of said delay stages available for switching into said series of said delay stages in said pipeline is equal to a load-use penalty for said pipeline.

9. The electronic processing device according to claim 1, wherein said pipeline having said delay stage switchable into and out of said pipeline is an integer pipeline.

10. The electronic processing device according to claim 9, wherein another of said pipelines is a load/store pipeline.

11. The electronic processing device according to claim 5, further comprising an instruction flow controller for determining which of the instructions in said pipelines can continue, and which of the instructions must stall and which results can be forwarded to said decode stage if said decode stage requires a result that is not immediately available to said decode stage.

12. The electronic processing device according to claim 11, wherein said instruction flow controller determines a stalling of the instructions and a forwarding of the results according to a relative age of the instructions in said pipelines.

13. The electronic processing device according to claim 11, wherein said instruction flow controller determines how many of said delay stages are switched into said pipeline and utilizes a Q-value in determining a stalling of the instructions and the forwarding of the results.

14. The electronic processing device according to claim 13, wherein said instruction flow controller determines the stalling of the instructions and the forwarding of the results according to a set of rules which provide relative ages of the instructions in said pipelines for different Q-values.

15. The electronic processing device according to claim 14, wherein the set of rules include the following rules for providing an age order of the instructions in different ones of said stages in said pipelines (A and B):
For Q=0: B-Ex2, A-Ex1, B-EX1, A-D, B-D, PD, F
For Q=1: B-Ex2, A-D, B-Ex1, A-Q1, B-D, PD, F
For Q=2: B-Ex2, A-Q1, B-Ex1, A-Q2, B-D, PD, F,
wherein said pipelines each have two execution stages (Ex1 and Ex2), said decode stage (D), said predecode stage (PD), a fetch stage (F) and said delay stages according to the Q-value.

16. A method of pipelining in an electronic processing device having at least two pipelines disposed in parallel to receive a series of instructions, each pipeline having a plurality of stages through which the instructions pass, which comprises the steps of:
providing a first respective instruction to a first stage of each of the pipelines at a first clock cycle; and
providing, at each subsequent clock cycle, a subsequent respective instruction to the first stage of each of the pipelines, and, unless upon a previous instruction being stalled in a respective pipeline, moving the subsequent respective instruction to a next stage of the respective pipeline; and
switching a delay stage into the respective pipeline to receive a next instruction upon the previous instruction being stalled in the respective pipeline.

17. The method of pipelining in the electronic processing device according to claim 16, wherein, if the previous instruction is stalled in the respective pipeline, the instructions in the other pipeline are not stalled or delayed.

18. The method of pipelining in the electronic processing device according to claim 16, which comprises switching the delay stage into the respective pipeline between a predecode stage and a decode stage of the respective pipeline, if the previous instruction is stalled in the decode stage, and switching the delay stage out of the respective pipeline if the predecode stage has no instruction available to pass to any decode stage.

19. The method of pipelining in the electronic processing device according to claim 16, which comprise providing a plurality of delay stages for switching into a series in the respective pipeline to increase or decrease an effective length of the respective pipeline.

20. The method of pipelining in the electronic processing device according to claim 19, which comprises making available the plurality of delay stages for switching into the respective pipeline between a predecode stage and a decode stage of the pipeline.

21. The method of pipelining in the electronic processing device according to claim 20, which comprises switching a delay stage, into the respective pipeline, which is adjacent the predecode stage per clock cycle if the previous instruction is stalled in the decode stage, and the delay stage adjacent the predecode stage is switched out of the respective pipeline per clock cycle if the predecode stage has no instruction to pass to the decode stage.

22. The method of pipelining in the electronic processing device according to claim 19, which comprises setting a maximum number of the delay stages available for switching into the respective pipeline to be equal to a load-use penalty for the respective pipeline.

23. The method of pipelining in the electronic processing device according to claim 16, which comprises forming the respective pipeline provided with the delay stage switchable into and out of the respective pipeline as an integer pipeline.

24. The method of pipelining in the electronic processing device according to claim 23, which comprises forming the other pipeline as a load/store pipeline.

25. The method of pipelining in the electronic processing device according to claim 16, which comprises determining which of the instructions in the pipelines can continue, which of the instructions must stall and which results can be forwarded to a decode stage if the decode stage requires a result that is not immediately available to the decode stage.

26. The method of pipelining in the electronic processing device according to claim 25, wherein the steps of determining the stalling of the instructions and the forwarding of the results comprises utilizing a relative age of the instructions in the pipelines.

27. The method of pipelining in the electronic processing device according to claim 25, wherein the steps of determining the stalling of the instructions and the forwarding of the results comprises determining how many delay stages are switched into the respective pipeline and utilizing a Q-value in determining the stalling of the instructions and the forwarding of the results.

28. The method of pipelining in the electronic processing device according to claim 27, wherein the step of determining the stalling of the instructions and the forwarding of the results comprises utilizing a set of rules which provide relative ages of the instructions in the pipelines for different Q-values.

29. The method of pipelining in the electronic processing device according to claim 28, which comprises setting up the set of rules to include the following rules for providing an age order of the instructions in different stages in the pipelines (A and B):
For Q=0: B-Ex2, A-Ex1, B-EX1, A-D, B-D, PD, F
For Q=1: B-Ex2, A-D, B-Ex1, A-Q1, B-D, PD, F
For Q=2: B-Ex2, A-Q1, B-Ex1, A-Q2, B-D, PD, F,
wherein the pipelines include two execution stages (Ex1 and Ex2), a decode stage (D), a predecode stage (PD), a fetch stage (F) and delay stages according to the Q-value.
